(19) United States
(12) Patent Application Publication
(10) Pub. No.: US 2008/0219300 A1
(43) Pub. Date: Sep. 11, 2008

(54) High Power Fiber Laser

(75) Inventors: Vladimir Krupkin, Rishon Le Zion (IL); Avishay Yaniv, Netania (IL); Elena Luria, Kiryat Ono (IL)

Correspondence Address: COOLEY GODWARD KRONISH LLP;ATTN: Patent Group, Suite 1100, 777 - 6th Street, NW, WASHINGTON, DC, 20001, US

(73) Assignee: ELBIT SYSTEMS ELECTRO-OPTICS ELOP LTD., Kiryat Weizmann, Rehovot (IL)

(21) Appl. No.: 12/088,378

(22) PCT Filed: Sep. 26, 2006
(86) PCT No.: PCT/IL06/01124

§ 371 Date: Mar. 27, 2008

(30) Foreign Application Priority Data
Sep. 27, 2005 (IL) 171129

(51) Int. Cl. H01S 3/00; H01S 3/23

(52) U.S. Cl. 372/6

(57) ABSTRACT

Fiber laser (130), for producing a single mode (SM) polarized single frequency (SF) high power laser beam of light, the fiber laser including an SF laser oscillator (132), a fiber laser pre amplifier (134, 150) and a high power fiber laser power amplifier (136, 200, 300), the fiber laser pre amplifier being optically coupled with the laser oscillator and the high power fiber laser power amplifier being optically coupled with the fiber laser pre amplifier, the SF laser oscillator for generating a laser beam of light having a predetermined frequency, the fiber laser pre amplifier for pre amplifying the laser beam of light and the high power fiber laser power amplifier for amplifying the laser beam of light, the high power fiber laser power amplifier including a fiber optic isolator (206, 302), at least one first amplification stage (202, 314) and at least one second amplification stage (204, 316), the fiber optic isolator being optically coupled with the fiber laser pre amplifier and the second amplification stage being optically coupled with the first amplification stage, the first amplification stage for amplifying the laser beam of light, the second amplification stage for further amplifying the laser beam of light and the second amplification stage outputting the laser beam of light (230, 310).

### FIELD OF THE DISCLOSED TECHNIQUE

The disclosed technique relates to high power fiber lasers in general, and to methods and systems for constructing high power fiber lasers for detecting air turbulence, in particular.

### BACKGROUND OF THE DISCLOSED TECHNIQUE

Air turbulence is a phenomenon wherein an air mass exhibits a velocity (i.e., the speed and the direction of motion) different than that of air surrounding the air mass, thereby creating, for example, aircraft wake vortices, updrafts or downdrafts. This air mass can be referred to as turbulent air. In general, turbulent air presents a danger to aircrafts flying in close proximity to the turbulent air, or through the turbulent air. Air turbulence may cause an aircraft to dangerously veer off course or even to crash if flying close to the ground (e.g., during takeoff or landing). It is therefore advantageous for the aircraft operator (e.g., a pilot) to be able to have advanced warnings if such turbulent air is in, or is in close proximity to, the flight path of the aircraft. The aircraft operator may then alter the course (i.e., either altitude or attitude or both) of the aircraft to avoid the turbulent air. Normally, clear air exhibits low reflectance. Therefore, in order for the reflected light from the turbulent air to be of sufficient power to enable detection, a high power laser is required.

U.S. Pat. No. 4,195,931, to Hara entitled “Clear Air Turbulence Detector” is directed to a system for detecting air turbulence using a high peak power Nd³+:YA1G pulsed laser and a Fabry-Perot interferometer. A high peak power pulsed laser beam is directed at a volume of interest where air turbulence may exist. When the high peak power laser beam impinges on air (i.e., either turbulent or not-turbulent), part of the incident light is scattered. Due to this scattering some of the laser light is reflected back towards the detector. The detected reflected light passes through the Fabry-Perot interferometer. The Fabry-Perot interferometer creates circular symmetric interference patterns associated with the spectrum of the reflected light on concentric ring anodes of an image dissector photomultiplier tube. The image of the interference pattern is then displayed to a user, who can determine if the interference pattern of the reflected light is different from the interference pattern of the light reflected from non-turbulent air. Alternatively, the reflected interference pattern can be analyzed by a correlation computer. The correlation computer correlates the received interference pattern with the interference pattern of non-turbulent air. An indicator indicates to the user when the received interference pattern significantly departs from the non-turbulent air interference pattern. The distance of the turbulent air from the aircraft is determined by the time elapsed from the transmission of the laser pulse to the reception of the reflected light.

U.S. Pat. No. 4,359,640 to Geiger entitled “Clear Air Turbulence Detection” is directed to a system for detecting clear air turbulence or wake vortex using an ultraviolet laser scanning an area of the flight path of an aircraft. According to Geiger, a parcel of air containing a relatively large amount of water vapor is warmer than the surrounding atmosphere and thereby produces an updraft (i.e., turbulence). Conversely, a parcel of air containing a relatively small amount of water vapor is cooler than the surrounding atmosphere and thereby produces a downdraft. Furthermore, ultraviolet radiation is generally absorbed by water vapor in the atmosphere. Therefore, the amount of non-absorbed ultraviolet radiation is inversely proportional to the amount of water vapor in the detected atmospheric volume scanned by the laser. Consequently, the amount of non-absorbed ultraviolet radiation is indicative of the direction of the draft (i.e., up or down). An ultraviolet laser scans the atmosphere in the path of the aircraft. The reflected ultraviolet radiation from the atmosphere is detected by a photodetector. The signal generated by the photodetector is applied to a Cathode Ray Tube (CTR). The scanning of the ray of the CTR is synchronized with the scanning motion of the laser beam. Thus, since the amount of reflected light is inversely proportional to the amount of water vapor in the atmosphere, regions with a relatively large amount of water vapor will appear as dark region on the CTR display, implying regions with an updraft. Conversely, regions with a relatively small amount of water vapor will appear as bright regions on the CTR display, implying regions with a downdraft.

Furthermore, according to Geiger, air turbulence can also be detected by measuring a change in the size of an aerosol by measuring the backscatter of both an ultraviolet laser and a blue laser incident on the measured air mass. Since air particles absorb or release thermal energy from the surrounding air mass, the size of the air particles changes proportionally to the additional energy (i.e., an increase or a decrease in energy). The rate of change in the aerosol diameter is directly related to the velocity of the measured air mass compared to the surrounding air, which can indicate turbulent air. A nitrogen gas laser (ultraviolet) and an organic dye laser (blue) scan the volume in front of the aircraft. By measuring the backscatter radiation from both the ultraviolet laser and the blue laser, a wide range of aerosol concentrations sizes can be measured.

U.S. Pat. No. 4,652,122 to Zincone et al., entitled “Gust Detection System” is directed to a system and a method for detecting air turbulence by a laser scanning the volume ahead of an aircraft. Initially, a scan of the aerosol, at a small focal distance from the aircraft, is performed to establish a reference curve of the relative speed between the aircraft and the surrounding air at different scanning angles. The relative speed is derived from the Doppler frequency shift of the reflected pulsed laser beam from the aerosol target. Additional scans at varying focal planes are also conducted. Air turbulence (e.g., updraft, downdraft or vortices) at these additional focal planes are detected according to the departure of the curves of the relative speed between the aircraft and the surrounding air at different scanning angles from the reference curve.

U.S. Pat. No. 5,694,408, to Boff et al. entitled “Fiber Laser Optic System and Associated Lasing Method” is directed to a system for amplifying a fiber laser to relatively high levels of output power. According to Bott et al., a laser signal source generates a primary laser signal. The primary laser signal is divided into a plurality of secondary beams by an optical distributor. Each of the secondary beams is then power amplified. The secondary beams are then combined to form a single laser beam having a power level greater than the predetermined power level of the primary laser signal. According to Bott et al., the optical distributor may include phase modulators. These phase modulators modulate the phases of the secondary beams. The phases of the secondary beams are modulated to have a predetermined phase relationship with a predetermined phase of a reference signal.

### SUMMARY OF THE DISCLOSED TECHNIQUE

It is an object of the disclosed technique to provide a novel laser system for detecting turbulent air in a volume of interest.

In accordance with the disclosed technique, there is thus provided a high-power fiber laser system, for detecting turbulent air in a volume of interest, the system comprising a fiber laser, transceiver optics, a scanner, an optical receiver, a controller and a processor. The transceiver optics is optically coupled with the fiber laser. The scanner is coupled with the transceiver optics, which is further optically coupled with the optical receiver. The controller is coupled with the scanner and with the processor. The fiber laser produces a single mode (SM) polarized single frequency (SF) high-power laser beam of light. The transceiver optics transmits the high-power laser beam of light and receives a laser beam of light reflected from turbulent air. The scanner scans the volume of interest with the high-power laser beam of light. The optical receiver detects a received laser beam of light and determines the frequency of the received laser beam of light. The processor determines if a Doppler shift exists between the high-power laser beam of light and the received laser beam of light, thereby detecting turbulent air in the volume of interest.

In accordance with another aspect of the disclosed technique, there is thus provided a single mode (SM) polarization maintaining (PM) optic fiber, comprising a doped core, an undoped core, a cladding and a coating. The doped core has a first elliptical shape. The undoped core surrounds the doped core, and has a second elliptical shape. The major axis of the first elliptical shape substantially coincides with the major axis of the second elliptical shape. The cross section area of the second elliptical shape is substantially larger than the cross section area of the first elliptical shape. The cladding surrounds the undoped core, and has a double-D shape, such that if the cladding were to be split longitudinally into two parts, each part of the cladding would have a D-shape. The coating surrounds the cladding, and has a circular shape. The major axis of the first elliptical shape and the major axis of the second elliptical shape substantially coincide with a longitudinal axis of the cladding.

In accordance with a further aspect of the disclosed technique, there is thus provided a fiber laser, for producing a single mode (SM) polarized single frequency (SF) high-power laser beam of light. The fiber laser comprising an SF laser oscillator, a fiber laser pre-amplifier and a high-power fiber laser power amplifier. The high-power fiber laser power amplifier further includes a fiber optic isolator, at least one first amplification stage, for amplifying the laser beam of light, and at least one second amplification stage, for further amplifying the laser beam of light. The at least one first amplification stage is optically coupled with the fiber laser pre-amplifier, and with the at least one second amplification stage. The at least one second amplification stage outputs the laser beam of light.

In accordance with another aspect of the disclosed technique, there is thus provided a fiber laser, for producing a single mode (SM) polarized single frequency (SF) high-power laser beam of light. The fiber laser comprising an SF laser oscillator, a fiber laser pre-amplifier and a high-power fiber laser power amplifier. The high-power fiber laser power amplifier further includes a fiber optical isolator, a channel coupler, a plurality of parallel fiber amplification channels, a plurality of phase modulators, a phase modulator controller and an optical combiner. The fiber optical isolator is optically coupled with the fiber laser pre-amplifier. The channel coupler is optically coupled with the optical isolator. Each of the phase modulators is coupled with the channel coupler, and with a respective one of the amplification channels. Each of the phase modulators is located before each of the amplification channels. The phase modulator controller is optically coupled with the phase modulators. The optical combiner is optically coupled with the output of each of the amplification channels. The fiber laser pre-amplifier pre-amplifies the laser beam of light. The fiber laser power amplifier amplifies the laser beam of light. The channel coupler splits the laser beam of light into a plurality of split laser beams of light. Each of the phase modulators modulates the phase of a respective one of the split laser beams of light. The phase modulator controller controls the phase of each of the split beams of light, such that no phase difference exists between the phases of the split beams of light. Each of the parallel amplification channels amplifies a respective split beam of light, and the optical combiner combines the split beams of light into a single amplified laser beam of light.

In accordance with a further aspect of the disclosed technique, there is thus provided a high-power fiber laser power amplifier, for amplifying a single mode (SM) polarized single frequency (SF) laser beam of light. The high-power fiber laser power amplifier comprises a fiber optical isolator, at least one first amplification stage and at least one second amplification stage. The at least one first amplification stage is optically coupled with the fiber optical isolator, and with the at least one second amplification stage. The at least one first amplification stage amplifies the laser beam of light. The at least one second amplification stage further amplifies the laser beam of light, and outputs the laser beam of light. The at least one first amplification stage and the at least one second amplification stage maintain the polarization of the laser beam of light, and maintain the laser beam of light in a single mode.

In accordance with another aspect of the disclosed technique, there is thus provided a high-power fiber laser power amplifier. The high-power fiber laser power amplifier comprises a fiber optical isolator, a channel coupler, a plurality of parallel fiber amplification channels, a plurality of phase modulators, a phase modulator controller and an optical combiner. The fiber optical isolator is optically coupled with the fiber laser pre-amplifier. The channel coupler is optically coupled with the optical isolator. Each of the phase modulators is coupled with the channel coupler, and with a respective one of the amplification channels. Each of the phase modulators is located before each of the amplification channels. The phase modulator controller is optically coupled with the phase modulators. The optical combiner is optically coupled with the output of each of the amplification channels. The fiber laser pre-amplifier pre-amplifies the laser beam of light. The fiber laser power amplifier amplifies the laser beam of light. The channel coupler splits the laser beam of light into a plurality of split laser beams of light. Each of the phase modulators modulates the phase of a respective one of the split laser beams of light. The phase modulator controller controls the phase of each of the split beams of light, such that no phase difference exists between the phases of the split beams of light. Each of the parallel amplification channels amplifies a respective split beam of light, and the optical combiner combines the split beams of light into a single amplified laser beam of light. The channel coupler, the plurality of parallel fiber amplification channels, the plurality of phase modulators, the phase modulator controller, and the optical combiner maintain the polarization of the laser beam of light, and maintain the laser beam of light in a single mode.

### BRIEF DESCRIPTION OF THE DRAWINGS

The disclosed technique will be understood and appreciated more fully from the following detailed description taken in conjunction with the drawings in which:

FIG. 1 is a schematic illustration of a LIDAR system, constructed and operative in accordance with an embodiment of the disclosed technique;

FIG. 2 is a schematic illustration of the fiber laser of FIG. 1, constructed and operative in accordance with another embodiment of the disclosed technique;

FIG. 3 is a schematic illustration of the pre-amplifier of FIG. 2, constructed and operative in accordance with a further embodiment of the disclosed technique;

FIG. 4A is a schematic illustration of the power amplifier of FIG. 2, constructed and operative in accordance with another embodiment of the disclosed technique;

FIG. 4B is a schematic illustration of the power amplifier of FIG. 2, constructed and operative in accordance with a further embodiment of the disclosed technique;

FIG. 4C is a schematic illustration of the power amplifier of FIG. 2, constructed and operative in accordance with another embodiment of the disclosed technique;

FIG. 5A is a schematic illustration of the cross-section of an optical fiber used in the prior art; and

FIG. 5B is a schematic illustration of the cross-section of an optical fiber, constructed and operative in accordance with another embodiment of the disclosed technique.

### DETAILED DESCRIPTION OF THE EMBODIMENTS

The disclosed technique overcomes the disadvantages of the prior art by providing a novel high power fiber laser design. The novel design enables the fiber laser to produce high power beams of light, on the order of millijoules (mJ), which are needed to detect air turbulence. The novel design also suppresses amplified spontaneous emissions (herein abbreviated ASE) in the fiber laser which could easily destroy the fiber laser from within due to the high power beams of light being generated. The novel design furthermore reduces non-linear effects of light in the fiber laser which can significantly reduce the maximum energy output of the high power beams of light.

As mentioned in the background section, air turbulence, in general, is the result of masses of air, each moving at different velocities, colliding with each other. This collision results in a turbulent, unpredictable and ever-changing movement of the air located in the vicinity of the air mass collision. For example, the air may move in the form of a vortex, creating air vortices. Hence the air located in this vicinity can be referred to as “turbulent air,” as “wake vortices” or as “air-pockets.” In general, the terms “turbulent air,” “wake vortices” and “air-pockets” will be used interchangeably in the description to describe air turbulence. In general, the velocity of air in an air-pocket is different than the velocity of air outside the air-pocket. Airplanes flying into such air-pockets usually experience sudden changes in altitude and attitude, which can affect an airplane and its flight path in various ways, ranging from mild alterations to the flight path of the airplane, to serious structural damage of the airplane and fatal crashes.

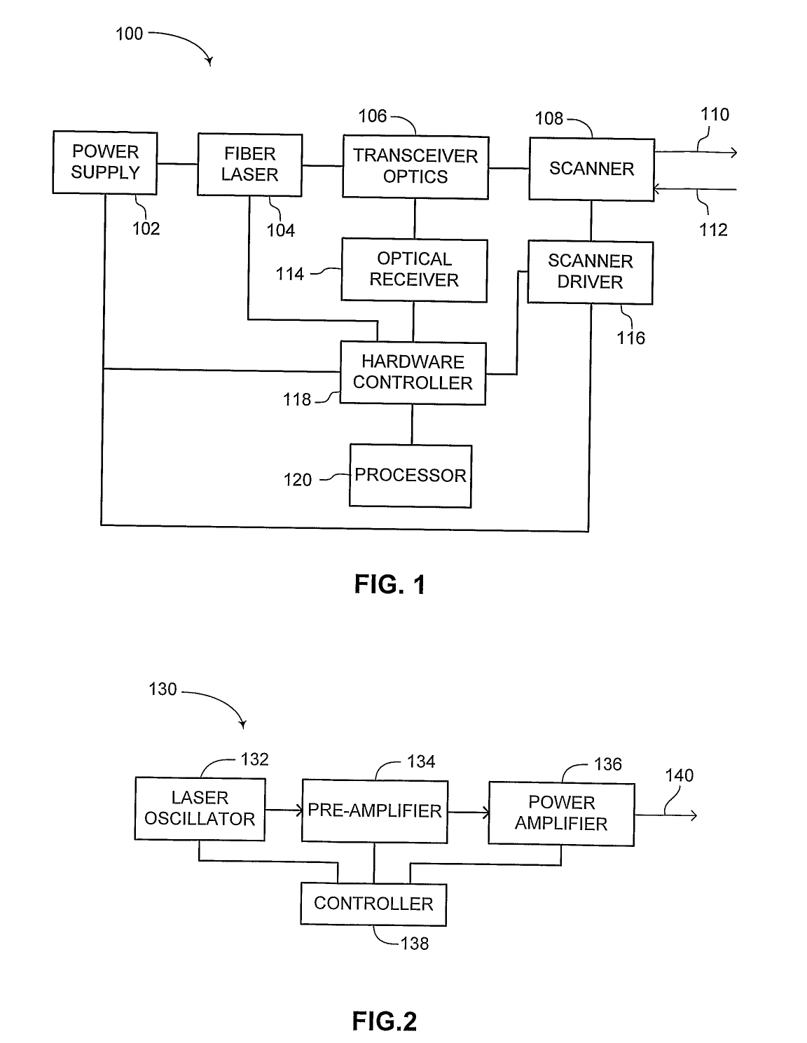

Reference is now made to FIG. 1, which is a schematic illustration of a LIDAR (light detection and ranging) system, generally referenced 100, constructed and operative in accordance with an embodiment of the disclosed technique. It is noted that in the following description, it is assumed that LIDAR system 100 is mounted on an aircraft. LIDAR system 100 is operative to detect air turbulence. LIDAR system 100 includes a power supply 102, a fiber laser 104, transceiver optics 106, scanner optics 108, an optical receiver 114, a scanner driver 116, a hardware controller 118 and a processor 120. LIDAR system 100 can also be mounted on a vehicle (not shown), a navel vessel, a spaceship or a building, for example, an air traffic control tower (not shown).

Hardware controller 118 is coupled with power supply 102, fiber laser 104, processor 120, optical receiver 114 and scanner driver 116. Power supply 102 is further coupled with fiber laser 104 and to scanner driver 116. Transceiver optics 106 is optically coupled with fiber laser 104, optical receiver 114 and scanner optics 108. Scanner optics 108 is further coupled with scanner driver 116. It is noted that scanner optics 108 and scanner driver 116 may be integrated into a single scanner (not shown).

Transceiver optics 106 includes a plurality of optical elements (not shown), such as a beam combiner (for aligning a transmitted light beam and a received reflected light beam onto the same optical axis), a telescope, a deflecting mirror and the like. Transceiver optics 106 is operative to transmit and receive beams of light on a single optical axis. Fiber laser 104 is constructed and operative in a manner further described with reference to FIGS. 2, 3, 4A, 4B and 4C. Hardware controller 118 is operative to coordinate and synchronize the operation of fiber laser 104, scanner driver 116 and processor 120.

Power supply 102 provides electrical power to fiber laser 104, hardware controller 118, optical receiver 114, and to scanner driver 116. Fiber laser 104 generates a high power pulsed beam of light, of a particular frequency, which is provided to transceiver optics 106. Transceiver optics 106 transmits the pulsed beam of light to scanner optics 108. Scanner driver 116 then instructs scanner optics 108 to scan a volume of interest in front of LIDAR system 100, in order to detect turbulent air. The pulsed beam of light, which is provided to scanner optics 108 by transceiver optics 106, is then emitted as a transmitted pulsed beam of light 110, towards the volume of interest in front of LIDAR system 100.

Due to the presence of particles and molecules (both not shown) in the volume of interest in front of LIDAR system 100, and the high power of transmitted pulsed beam of light 110, transmitted pulsed beam of light 110 will be reflected back to LIDAR system 100 as a reflected pulsed light beam 112. If transmitted pulsed beam of light 110 impinges on particles and molecules in an air-pocket, the difference in velocity between the air near LIDAR system 100, and the air in the air-pocket, causes a Doppler shift in the frequency of reflected pulsed beam of light 112, as is known in the art. The difference between the frequency of the transmitted pulsed beam of light and the frequency of the reflected beam of light, due to the Doppler shift, may be on the order of tens of megahertz (MHz).

Reflected pulsed light beam 112 is detected by optical receiver 114 via scanner optics 108 and transceiver optics 106. Optical receiver 114 provides hardware controller 118 with information indicative of the characteristics of reflected pulsed light beam 112, for example the frequency of received reflected pulsed light beam 112. Hardware controller 118 then provides this information to processor 120. Processor 120 analyzes the information regarding reflected pulsed light beam 112, and determines if reflected pulsed light beam 112 is reflected from an air-pocket. Processor 120 determines if reflected pulsed light beam 112 was reflected from an air-pocket by determining if a Doppler shift, on the order of tens of MHz, occurred between transmitted pulsed beam of light 110 and reflected pulsed light beam 112. If an air-pocket is identified by processor 120, a warning system (not shown) can warn the pilot of the presence of the air-pocket and provide the pilot with its location relative to the location of the airplane. It is noted that hardware controller 118 and processor 120 may be integrated into a single controller-processor unit (not shown), which may be, for example, a controller-processor computer.

In order to detect air-pockets at a reasonable distance, for example a hundred meters to three kilometers in front of an airplane, fiber laser 104 must generate transmitted pulsed beam of light 110 such that it has a pulse energy on the order of millijoules. This magnitude of pulse energy is required to ensure that reflected pulsed light beam 112, which reflects off of microscopic particles and molecules, has sufficient energy to reach transceiver optics 106 such that its frequency can be determined. In general, pulse energies on the order of millijoules are difficult to generate in fiber lasers due to the non-linear effects of high power light on fiber optic cables. Pulse energies on the order of millijoules are also difficult to generate because of ASE that may occur in the amplification stages of fiber laser 104 (all not shown). ASE can seriously damage, or even destroy, the components of fiber laser 104 (all not shown), due to the high level of amplification in the fiber laser. It is noted that fiber optic cables can also be referred to as simply fibers.

In particular stimulated Brillouin scattering (herein abbreviated SBS), which is a non-linear effect of light that occurs in fibers, can significantly limit the maximum pulse energy that can be generated and transmitted in a given direction of a fiber. SBS occurs when a pulsed beam of light, traveling in an optical fiber, reaches a sufficient level of power to cause acoustic vibration waves in the glass that makes up the fiber. This sufficient level of power can be as low as a few milliwatts (mW) in a single mode (herein abbreviated SM) fiber. These acoustic vibration waves cause the index of refraction of the glass to change, which in turn causes the pulsed beam of light traveling in the fiber to scatter. The scattered light travels back through the fiber, in the opposite direction, towards the source that originally generated the pulsed beam of light, for example, towards a laser diode. The scattered light thereby attenuates the pulsed beam of light, by interfering with the pulsed beam of light as it travels back towards, for example, a laser diode. Furthermore, the attenuation increases non-linearly (i.e., to a power of two or higher) as the pulse energy of the pulsed beam of light increases. Therefore, when a pulsed beam of light reaches a particular pulse energy, the non-linear effect of SBS will limit any increase in pulse energy of the pulsed beam of light. In general, SBS limits the maximum amount of pulse energy that can be produced in fiber lasers to a pulse energy level that is less than the required pulse energy level needed to detect air turbulence. Also, SBS effects increase with an increase in optical path. Therefore, the longer high energy pulses have to travel down a fiber optic cable, the greater amount of attenuation SBS effects can have on the pulses of light.

Reference is now made to FIG. 2, which is a schematic illustration of the fiber laser of FIG. 1, generally referenced 130, constructed and operative in accordance with another embodiment of the disclosed technique. Fiber laser 130 includes a laser oscillator 132, a pre-amplifier 134, a power amplifier 136 and a controller 138. It is noted that laser oscillator 132 can be constructed as a distributed feedback (herein abbreviated DFB) laser diode, or as a single frequency, fiber laser. The fiber laser can be constructed from an erbium doped fiber. Laser oscillator 132 can also be constructed as at least one of a continuous wave laser, a single mode laser, a polarization maintaining laser, or a single frequency laser. Laser oscillator 132 can generate pulsed beams of lights, with the pulse length of the output beam of light on the order of hundreds of nanoseconds. The pulse length of the output beam of light can be adjusted via controller 138. The pulse repetition rate at which laser oscillator 132 generates pulsed beams of light is generally on the order of hundreds of hertz to hundreds of kilohertz.

Laser oscillator 132 is optically coupled with pre-amplifier 134, which is in turn optically coupled with power amplifier 136. Controller 138 is coupled with laser oscillator 132, pre-amplifier 134 and power amplifier 136. In general, all the components in a fiber laser are optically coupled by fibers. It is noted that fiber laser 130 is constructed using a master oscillator power amplifier (herein abbreviated MOPA) approach.

In order to detect air turbulence, fiber laser 130 is constructed to generate beams of light having a pulse duration, or a pulse length, on the order of hundreds of nanoseconds. Also, the fibers of fiber laser 130 are single mode (herein abbreviated SM) fibers, so that the pulsed beam of light transmitted through the fibers remains at a single mode. Such fibers typically have a core diameter of approximately a few micrometers. Furthermore, since the Doppler shift (expected to occur if reflected pulsed light beam 112 (FIG. 1) reflects from an air-pocket) is on the order of tens of MHz, then fiber laser 130 must be constructed to have a narrower bandwidth which is different than the expected Doppler shift. For example, the bandwidth of fiber laser 130 is less than 1 MHz, as the Doppler shift is of a few MHz. Fiber laser 130 is a narrow bandwidth laser. Also, fiber laser 130 is constructed to generate a diffraction limited beam of light, such that the amount of beam divergence of the output pulsed beam of light is at its minimum. Diffraction limited beams are used to transmit SM beams of light out of fiber laser 130.

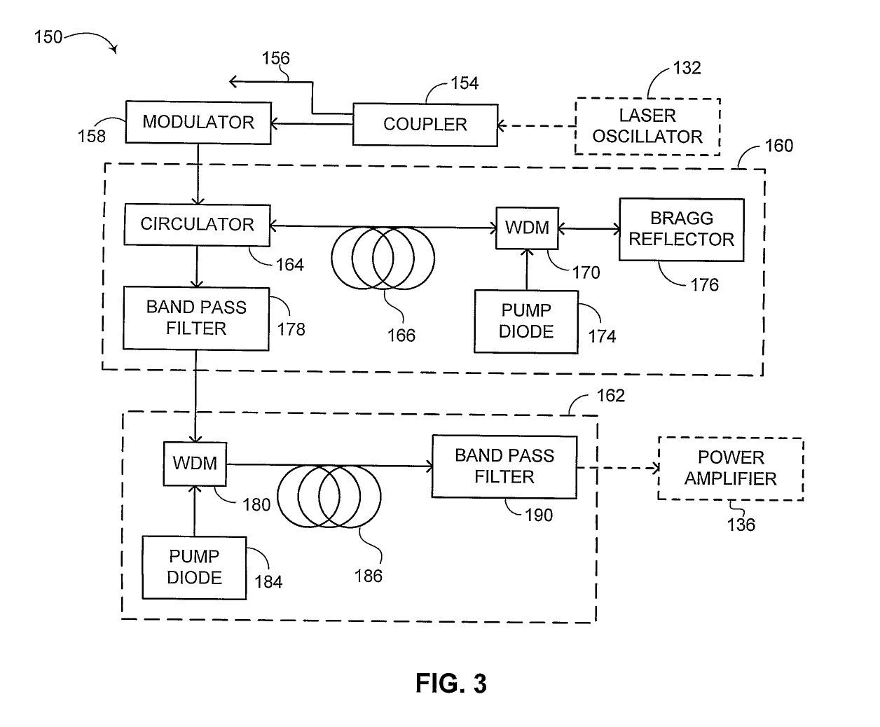

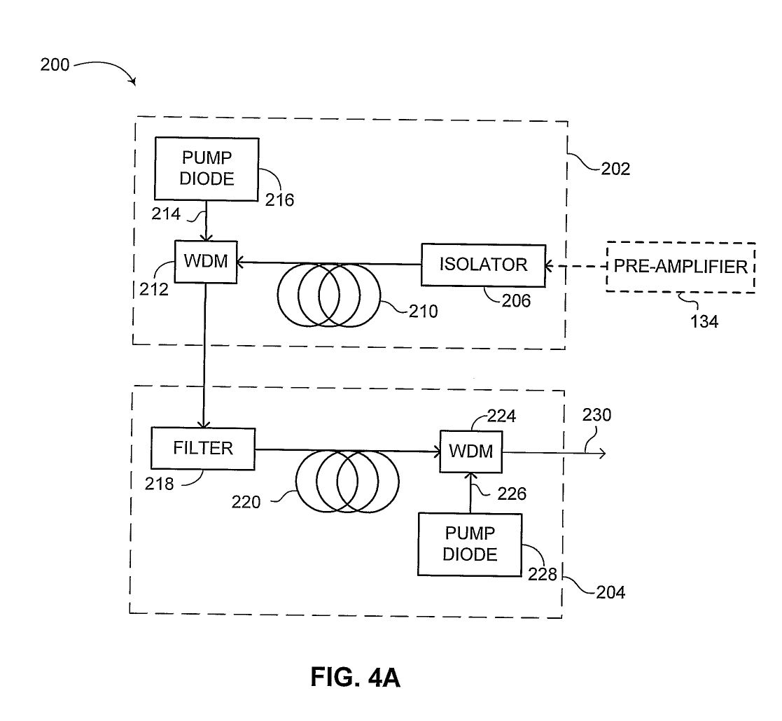

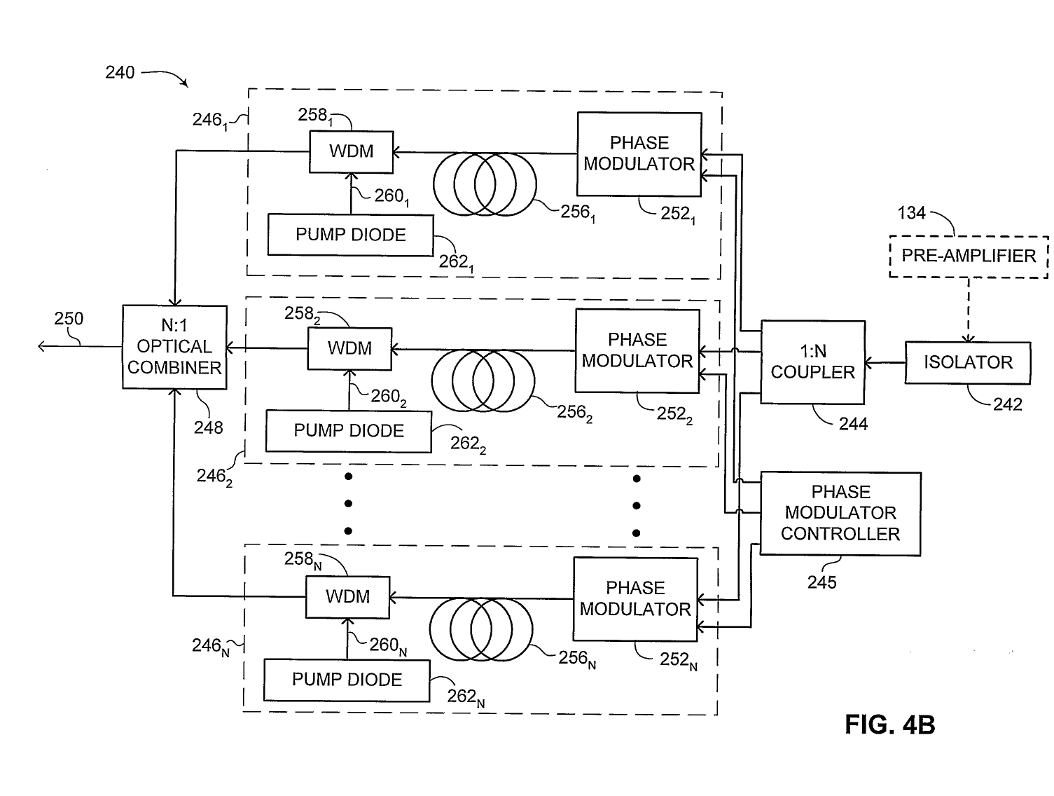

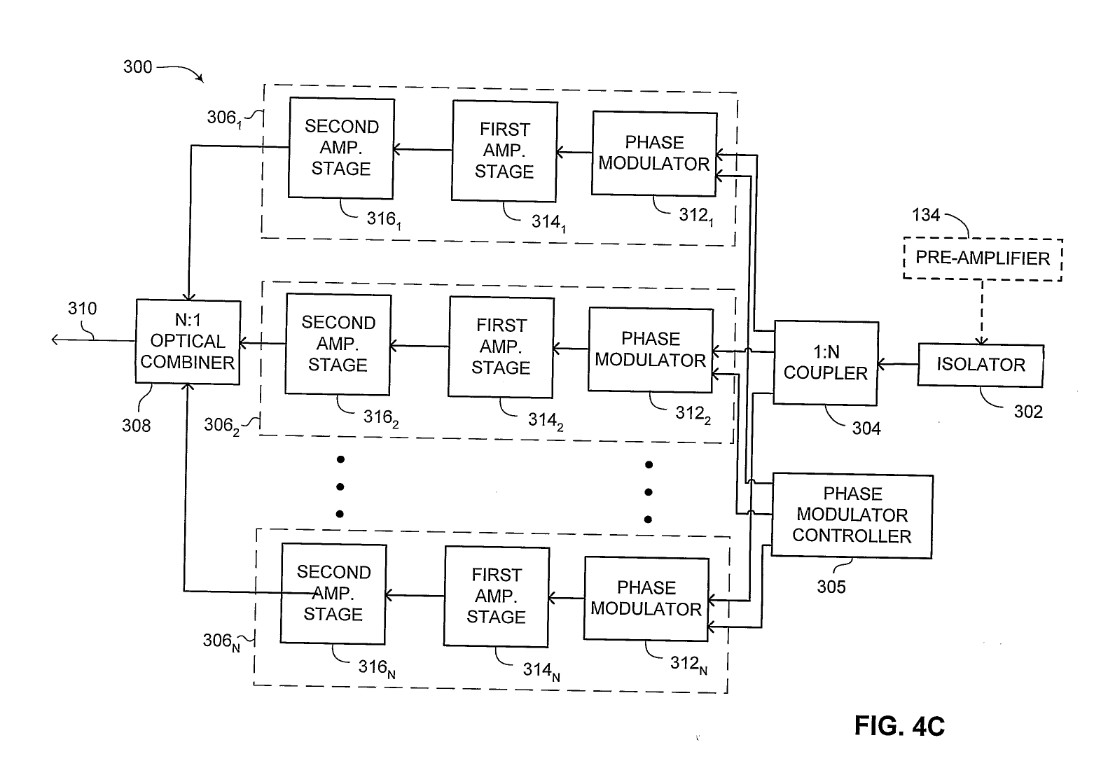

Laser oscillator 132 generates a pulsed beam of light with pulse energy on the order of tens of nanojoules. The wavelength of light laser oscillator 132 generates can be 1550 nanometers. Pre-amplifier 134 amplifies the pulsed beam of light such that the pulse energy is on the order of hundreds of microjoules. Power amplifier 136 then amplifies the pulsed beam of light such that the pulse energy is on the order of millijoules. The output of power amplifier 136 is a high power pulsed beam of light 140. It is noted, therefore, that fiber laser 130 achieves a pulse energy amplification of approximately six orders of magnitude. In general, pre-amplifier 134 increases the pulse energy of pulsed beam of light 140 below the energy level where SBS effects begin to happen in the fibers of fiber laser 130, as further described with reference to FIG. 3. Power amplifier 136 then further increases the pulse energy of pulsed beam of light 140, as further described with reference to FIGS. 4A, 4B and 4C. Controller 138 synchronizes pump diodes (not shown) in pre-amplifier 134 and power amplifier 136 that enable the pulse energy amplification of the pulsed beam of light. Controller 138 also monitors and controls all the basic electronic components (not shown) contained within laser oscillator 132, pre-amplifier 134 and power amplifier 136.

Reference is now made to FIG. 3, which a schematic illustration of the pre-amplifier of FIG. 2, generally referenced 150, constructed and operative in accordance with a further embodiment of the disclosed technique. Pre-amplifier 150 includes a coupler 154, a modulator 158, a pre-amplifier stage 160 and a booster stage 162. Coupler 154 is optically coupled with modulator 158. Modulator 158 is optically coupled with pre-amplifier stage 160, which is in turn optically coupled with booster stage 162. It is noted that coupler 154 is optically coupled with laser oscillator 132 (FIG. 2), and that booster stage is optically coupled with power amplifier 136 (FIG. 2).

In general, laser oscillator 132 generates a low energy beam of light, on the order of tens of microwatts. Coupler 154 then splits the low energy beam of light into two beams of light. One beam of light is provided by a fiber optic cable 156 as a reference output of a few milliwatts. The reference output is used to compare the frequency of the transmitted beam of light to the frequency of the reflected beam of light in order to determine if a Doppler shift has occurred in the reflected beam of light. The measured Doppler shift is proportional to the detected air turbulence, as described with reference to FIG. 1. The other beam of light is provided to modulator 158, which modulates the beam of light and provides a pulsed beam of light to pre-amplifier stage 160. The pulse energy of the beam of light provided to pre-amplifier stage 160 is approximately a few nanojoules. It is noted that pre-amplifier stage 160 is a double pass amplifying stage. Pre-amplifier stage 160 amplifies the low energy beam of light twice, and provides the amplified beam of light to booster stage 162. The beam of light is amplified by three orders of magnitude. The pulse energy of the beam of light provided to booster stage 162 is approximately a few tens microjoules. Booster stage 162 further amplifies the amplified beam of light and transmits the beam of light towards power amplifier 136.

Pre-amplifier stage 160 includes a circulator 164, an erbium doped fiber (herein abbreviated EDF) 166, a wavelength division multiplexer (herein abbreviated WDM) 170, a narrow band Bragg reflector 176, a fiber pump diode 174, and a band pass filter 178. A passive saturable absorber (not shown) may optionally be included in pre-amplifier stage 160 for suppressing ASE. A polarizer (not shown) may also be optionally included in pre-amplifier stage 160. Circulator 164 is optically coupled with modulator 158, EDF 166 and band pass filter 178. EDF 166 is optically coupled with WDM 170. WDM 170 is optically coupled with both narrow band Bragg reflector 176 and fiber pump diode 174. If the pre-amplifier stage 160 includes a polarizer, then that polarizer is placed between WDM 170 and narrow band Bragg reflector 176, wherein that polarizer is coupled with both WDM 170 and narrow band Bragg reflector 176, and hence, in such a configuration, WDM 170 is not directly coupled with narrow band Bragg reflector 176. The polarizer significantly increases the extinction ratio (i.e., the ratio of light beams having the polarization of the polarizer to light beams not having the polarization of the polarizer) of pre-amplifier stage 160 by preventing non-polarized beams of lights from propagating through pre-amplifier stage 160. In general, as mentioned above with reference to FIG. 2, all the components in fiber laser 130 (FIG. 2) are optically coupled by optic fibers. All the components in pre-amplifier stage 160 are coupled with one another by standard SM polarization maintaining (herein abbreviated PM) fibers. EDF 166 is a single mode, single clad, polarization maintaining fiber. Fiber pump diode 174 can be a fiber coupled laser diode. Narrow band Bragg reflector 176 can be a fiber Bragg grating (not shown).

Circulator 164 receives the phase modulated pulsed low energy beam of light from modulator 158. Circulator 164 directs the low energy beam of light towards EDF 166. EDF 166 amplifies the low energy beam of light. This amplification is achieved by using fiber pump diode 174, which pumps EDF 166 through WDM 170. Fiber pump diode 174 generates a beam of light, for pumping EDF 166, on the order of hundreds of milliwatts, for example a beam of light having a power ranging from 100 to 500 milliwatts. WDM 170 allows EDF 166 to receive the pump light generated from fiber pump diode 174. WDM 170 provides the amplified beam of light to narrow band Bragg reflector 176, which reflects the amplified beam of light back to WDM 170, which in turn, transmits the amplified beam of light back through EDF 166 a second time. It is noted that the optic fiber separating WDM 170 and narrow band Bragg reflector 176 may be of a predetermined length in order to introduce a specific delay in time between the low energy beam of light directed from circulator 164 towards EDF 166 and the double pass amplified beam of light directed from WDM 170 to EDF 166. In general, a separation length (i.e., a delay line) of substantially 1 meter will result in a delay of substantially 10 nanoseconds, whereas a separation length of substantially 100 meters will result in a delay of substantially 1 microsecond. The predetermined length of the delay line depends on the application of the disclosed technique and can be determined by the person skilled in the art. For example, to detect air turbulence, the delay line should be substantially 100 meters in length resulting in a delay of substantially 1 microsecond.

The delay in time substantially determines the difference in time when the low energy beam of light begins to propagate from circulator 164 towards EDF 166 and when the double pass amplified beam of light begins to propagate from WDM 170 to EDF 166. In the disclosed technique, a delay line is used to localize the amplification (i.e., energy extraction) of the low energy beam of light such that only the beam of light propagating from WDM 170 to EDF 166 is amplified substantially. If both the low energy beam of light and the double pass amplified beam of light were amplified substantially, then the amplification of the beam of light propagating from WDM 170 to EDF 166 may become non-linear. In order to enable a linear increase (i.e., amplification) in the energy of the beam of light propagating from WDM 170 to EDF 166, a delay line is only used between WDM 170 and narrow band Bragg reflector 176. In general, substantial energy extraction (i.e., amplification) occurs in beams of light only when delay lines are used.

The delay line is also used to avoid the formation of standing waves in EDF 166. In general, if no delay line was used, then when the low energy beam of light propagating from circulator 164 towards EDF 166 comes in contact and interferes with the double pass amplified beam of light propagating from WDM 170 to EDF 166, standing waves can form. Standing waves can create modulations which are not stable, thereby yielding a beam of light which is not suited for detecting air turbulence. As such, a delay line is used between WDM 170 and narrow band Bragg reflector 176 to avoid the formation of standing waves in EDF 166.

Narrow band Bragg reflector 176 ensures that only light of the wavelength, generated initially by laser oscillator 132, is reflected back through EDF 166 and no ASE and none of the pump light generated by fiber pump diode 174. Circulator 164 directs the double pass amplified beam of light towards band pass filter 178. Band pass filter 178 transmits the beam of light having only such wavelength, initially emitted from laser oscillator 132, to pass there through. Band pass filter 178, as well as narrow band Bragg reflector 176, are included in pre-amplifier stage 160 to suppress any ASE that may result from fiber EDF 166.

Booster stage 162 includes a WDM 180, a fiber pump diode 184, an EDF 186, and a band pass filter 190. WDM 180 is optically coupled with fiber pump diode 184, EDF 186 and band pass filter 178. A passive saturable absorber (not shown) may optionally be included in booster stage 162 for absorbing ASE. EDF 186 is optically coupled with band pass filter 190. All the components in booster stage 162 are coupled with one another by SM PM circular shaped fibers. Fiber pump diode 184 can be a low cost fiber coupled laser diode. EDF 186 is a single mode, single clad, large mode area, polarization maintaining fiber. Large mode area fibers are fibers that have a large core diameter, compared with standard communication fibers, usually on the order of tens of micrometers. Fiber pump diode 184 generates a beam of light, for pumping EDF 186, on the order of watts, for example a beam of light having a power up to 1 watt. Band pass filter 190 prevents ASE from EDF 186 from passing to power amplifier 136.

Band pass filter 178 provides the double pass amplified beam of light to WDM 180. WDM 180 provides the beam of light to EDF 186, which amplifies the beam of light. This amplification is achieved by using fiber pump diode 184, which pumps EDF 186. WDM 180 allows the beam of light produced by fiber pump diode 184 to be provided to EDF 186. It is noted that in booster stage 162, the amplified beam of light is passed through EDF 186 only once. Band pass filter 190 provides the amplified beam of light to power amplifier 136. The pulse energy of the beam of light, after being amplified thrice, is on the order of tens of microjoules.

Reference is now made to FIG. 4A, which is a schematic illustration of the power amplifier of FIG. 2, generally referenced 200, constructed and operative in accordance with another embodiment of the disclosed technique. It is noted that power amplifier 200 is constructed in a serial configuration. Power amplifier 200 includes a first amplification stage 202 and a second amplification stage 204. First amplification stage 202 is optically coupled with second amplification stage 204. It is noted that first amplification stage 202 is optically coupled with pre-amplifier 134 (FIG. 2).

First amplification stage 202 receives a pulsed beam of light, which has already been amplified to have pulse energy on the order of tens of microjoules, by pre-amplifier 134. First amplification stage 202 amplifies the pulsed beam of light, and provides the amplified beam of light to second amplification stage 204. The pulse energy of the beam of light provided to second amplification stage 204 is approximately a few hundred microjoules. Second amplification stage 204 further amplifies the amplified beam of light and outputs a pulsed beam of light 230. Pulsed beam of light 230 can be directed towards a volume of interest to be scanned in order to detect air turbulence. The pulse energy of pulsed beam of light 230 is approximately a few millijoules.

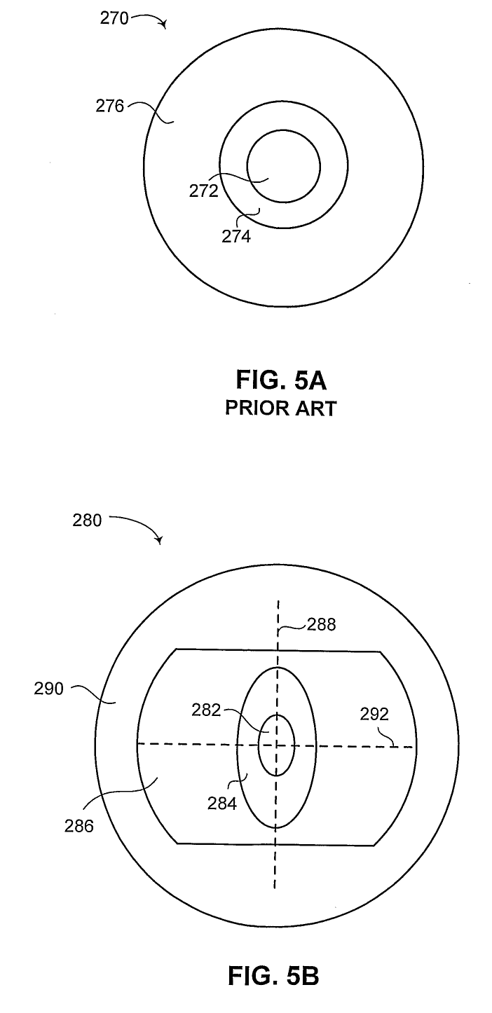

First amplification stage 202 includes an isolator 206, an erbium-ytterbium doped fiber (herein abbreviated EYDF) 210, a WDM 212, a pump diode 216, and fiber optic cable 214. A passive saturable absorber (not shown) may optionally be included in first amplification stage 202 for absorbing ASE and SBS. WDM 212 can be a custom free space combiner. Pump diode 216 can be a conductive cooled, fiber coupled single emitter laser diode, or a bar laser diode. Isolator 206 is optically coupled with band pass filter 190 (FIG. 3), and may be optically coupled with EYDF 210. WDM 212 is optically coupled with pump diode 216, EYDF 210 and second amplification stage 204. Fiber optic cable 214 optically couples pump diode 216 to WDM 212. All the components in first amplification stage 202 are coupled with one another by fibers. Isolator 206 can be constructed as a free space optical device. Free space optical devices transmit and receive light through the medium of air and not through fibers. EYDF 210 is a single mode, double clad, large mode area, polarization maintaining fiber (see FIG. 5B). Double clad fibers are fibers whereby a beam of light can be transmitted through the core, as well as the cladding, of the fibers of EYDF 210. Such double clad fibers are further explained with reference to FIG. 5B. Pump diode 216 can be a fiber coupled laser diode, or a laser diode array.

Isolator 206 receives the amplified pulsed beam of light from band pass filter 190. Isolator 206 then directs the pulsed beam of light, via fiber optic cable 208 (or via free space), towards EYDF 210. As mentioned with reference to FIG. 2, the energy of the pulsed beam of light that initially reaches power amplifier 200 is below the threshold of SBS effects. Power amplifier 200 will further amplify the pulsed beam of light to energies where SBS effects can attenuate the pulse energy of the pulsed beam of light. Isolator 206 is therefore included in first amplification stage 202 in order to prevent SBS from reflecting back into pre-amplifier 134 (FIG. 2). This prevention is further enhanced by band pass filter 190 (FIG. 3), with which isolator 206 is coupled. Isolator 206 is also used for preventing ASE and pump light from the fiber from interfering destructively with pre-amplifier 134. EYDF 210 amplifies the pulsed beam of light. This amplification is achieved by using pump diode 216, which pumps EYDF 210 via WDM 212. Pump diode 216 generates a beam of light, for pumping EYDF 210, on the order of tens of watts, for example a beam of light having a power ranging from 5 to 20 watts. WDM 212 allows EYDF 210 to receive the beam of light generated by pump diode 216 without interference of the pulsed beam of light being amplified by EYDF 210.

Second amplification stage 204 includes a filter 218, an EYDF 220, a WDM 224, a pump diode 228, and a fiber optic cable 226. A passive saturable absorber (not shown) may optionally be included in second amplification stage 204 for absorbing ASE and SBS. Filter 218 can be a band pass filter, an isolator, a switch or a Fabry-Perot (FP) filter. WDM 224 can be a custom free space combiner. Pump diode 228 can be a conductive cooled, fiber coupled single emitter laser diode, or a bar laser diode. Filter 218 is optically coupled with EYDF 220 and WDM 212. WDM 224 is optically coupled with pump diode 228 and EYDF 220. Fiber optic cable 226 optically couples pump diode 228 to WDM 224. EYDF 220 is a single mode, double clad, large mode area, polarization maintaining fiber (see FIG. 5B). Pump diode 228 can be a fiber coupled laser diode. Since the energy transmitted through second amplification stage 204 is the largest in all of fiber laser 130 (FIG. 2), the SBS effect therein is therefore thought to be the strongest. Filter 218 is therefore used for preventing ASE from EYDF 220, as well as SBS effects, from destroying the amplified beam of light, as mentioned above regarding isolator 206.

WDM 212 provides the amplified beam of light to filter 218. Filter 218 provides the amplified beam of light to EYDF 220, which further amplifies the amplified beam of light. This amplification is achieved by using pump diode 228, which pumps EYDF 220. WDM 224 allows the beam of light produced by pump diode 228 to be provided to EYDF 220. It is noted that in second amplification stage 204, the amplified beam of light is passed through EYDF 220 only once. The energy of the beam of light, after being further amplified, is on the order of a few millijoules. WDM 224 then outputs amplified beam of light 230.

In general, all the filters used in fiber laser 130, including band pass filter 178, band pass filter 190, isolator 206 and filter 218, are very narrow in bandwidth (i.e., notch filters), letting only a very small range of wavelengths through. In general, the bandwidth of the filters used in fiber laser 130 is narrower than the Brillouin shift (i.e., the frequency difference between the frequency of a laser and the frequency at which SBS effects occur) and the ASE shift (i.e., the frequency difference between the frequency of a laser and the frequency at which ASE occurs). This narrow bandwidth is needed in order to suppress SBS, as well as ASE, thereby preventing from reflecting back through fiber laser 130, where they could potentially destroy the components of the fiber laser due to the high energy of pulsed beams of light. Furthermore, all of the filters used in fiber laser 130 are constructed to transmit light at a wavelength initially generated by laser oscillator 132. All other beams of light generated in fiber laser 130, for example, beams of light from pump diodes, ASE or SBS, are filtered such that they are confined within a particular amplification stage and cannot propagate through fiber laser 130. Also, in general, each amplification stage, for example, pre-amplifier stage 160, booster stage 162, first amplification stage 202, second amplification stage 204 and amplification channels 246₁, 246₂ and 246_{N} (all from FIG. 4B), has a band pass filter located after the amplification stage, for protecting fiber laser 130 from high energy backscatter or reflections that may be generated by each amplification stage. In high power fiber lasers, these high energy backscatter or reflections can severely limit the maximum pulse energy of the amplified pulsed beam of light.

Reference is now made to FIG. 4B, which is a schematic illustration of the power amplifier of FIG. 2, generally referenced 240, constructed and operative in accordance with a further embodiment of the disclosed technique. It is noted that power amplifier 240 is constructed in a parallel configuration, and includes N parallel amplification channels. Power amplifier 240 includes an isolator 242, a 1:N (i.e., 1-to-N) coupler 244, a phase modulator controller 245, amplification channels 246₁, 246₂ and 246_{N} and an N:1 (i.e., N-to-1) optical combiner 248. It is noted that the ‘N,’ in 1:N coupler 244 and N:1 optical combiner 248, can be a natural number, which determines the number of amplification channels in power amplifier 240. It is further noted that hereinafter, 1:N coupler 244 will be referred to as coupler 244, and N:1 optical combiner 248 will be referred to as optical combiner 248. Coupler 244 and optical combiner 248 are both polarization maintaining. Optical combiner 248 can include mirrors (not shown), for optically combining N beams of light into a single beam of light. Isolator 242 is optically coupled with coupler 244. Coupler 244 is optically coupled with amplification channels 246₁, 246₂ and 246_{N}, which are in turn each optically coupled with optical combiner 248. Phase modulator controller 245 is optically coupled with each of amplification channels 246₁, 246₂ and 246_{N}. It is noted that isolator 242 is optically coupled with pre-amplifier 134 (FIG. 2).

Isolator 242 receives a pulsed beam of light, from pre-amplifier 134. As mentioned with reference to FIG. 2, the energy of the pulsed beam of light that initially reaches power amplifier 240 is below the limit of beginning to exhibit SBS effects. Power amplifier 240 further amplifies the pulsed beam of light. Isolator 242 is included in power amplifier 240 in order to prevent back reflections and ASE, coming from pulsed beams of light having a pulse energy on the order of tens or hundreds of microjoules, from reflecting back into pre-amplifier 134 (FIG. 2). This prevention is further enhanced by band pass filter 190 (FIG. 3), with which isolator 242 is coupled. Isolator 242 is also used for preventing pump light from pump diodes 262₁, 262₂ and 262_{N}, which are included in amplification channels 246₁, 246₂ and 246_{N}, from interfering with pre-amplifier 134, as mentioned above regarding band pass filter 178 (FIG. 3) and band pass filter 190. Isolator 242 then provides the pulsed beam of light to coupler 244, which splits the pulsed beam of light into N beams of light. For example, coupler 244 can split the pulsed beam of light into 4 beams of light. Each of the N beams of light is provided to each one of amplification channels 246₁, 246₂ and 246_{N}.

Each amplification channel then further amplifies the pulsed beam of light. Each amplification channels then provides the pulsed beam of light to optical combiner 248, which combines all the N beams of light into a single beam of light. The energy of combined beam of light 250 is significantly higher than the energy of each single light beam. In this manner, the output light beam energy achieved is higher than the limit of each single amplification channel. The pulse energy of each of the N beams of light exiting amplification channels 246₁, 246₂ and 246_{N} is approximately a few hundred microjoules. Optical combiner 248 then outputs a pulsed beam of light 250. Pulsed beam of light 250 can be directed towards a volume of interest to be scanned in order to detect air turbulence. The energy of pulsed beam of light 250 is approximately a few millijoules.

In general, optical combiner 248 optically combines the pulsed beams of light exiting amplification channels 246₁, 246₂ and 246_{N}, such that none of the pulsed beams of light interference destructively, thereby attenuating the pulse energy of the combined single pulsed beam of light. Destructive interference between the pulsed beams of light exiting amplification channels 246₁, 246₂ and 246_{N} is prevented by phase modulator controller 245. Phase modulator controller 245 modulates the phase of each of the N beams of light, provided by coupler 244 to each of phase modulators 252₁, 252₂ and 252_{N} (described further), such that there is no phase difference between the phases of each of the N beams of light. As such, when the N beams of light exit amplification channels 246₁, 246₂ and 246_{N} towards optical combiner 248, each beam of light will exit with the same phase and will therefore interfere constructively in optical combiner 248.

Amplification channels 246₁, 246₂ and 246_{N} are identical to one another. As such, only amplification channel 246₁ will be fully described as the full description of the other amplification channels are identical. Amplification channel 246₁ includes a phase modulator 252₁, an EYDF 256₁, a WDM 258₁, a pump diode 262₁, and a fiber optic cable 260₁. Pump diode 262₁ can be a conductive cooled, fiber coupled single emitter laser diode, or a bar laser diode. WDM 258₁ can be a custom free space combiner. Phase modulator 252₁ is optically coupled with EYDF 256₁ and coupled with phase modulator controller 245. It is noted that each of phase modulators 252₁, 252₂ and 252_{N} are coupled with phase modulator controller 245. WDM 258₁ is optically coupled with fiber pump diode 262₁, EYDF 256₁ and optical combiner 248. It is noted that each of WDM 258₁, 258₂ and 258_{N} are optically coupled with optical combiner 248. Fiber optic cable 260₁ optically couples pump diode 262₁ to WDM 258₁. In general, as mentioned above with reference to FIG. 2, all the components in fiber laser 130 (FIG. 2) may be optically coupled by fibers. All the components in amplification channels 246₁, 246₂ and 246_{N} are coupled with one another by fibers. EYDF 256₁ is a single mode, double clad, large mode area, polarization maintaining fiber. Such double clad fibers are further explained with reference to FIG. 5B. Pump diode 262₁ can be a fiber coupled laser diode, a fiber coupled single emitter laser diode, or a fiber coupled bar array laser.

Phase modulator 252₁ receives a split pulsed beam of light from coupler 244. Phase modulator 252₁ then directs the pulsed beam of light towards EYDF 256₁. EYDF 256₁ amplifies the pulsed beam of light. This amplification is achieved by using pump diode 262₁, which pumps EYDF 256₁ via WDM 258₁. Pump diode 262₁ generates a beam of light, for pumping EYDF 256₁, on the order of several watts, for example a beam of light having an energy ranging from up to 30 watts. WDM 258₁ allows EYDF 256₁ to receive the beam of light generated from pump diode 262₁ without interference from the pulsed beam of light being amplified by EYDF 256₁.

It is noted that since each amplification stage of fiber laser 130 (FIG. 2) significantly increases the pulse energy of the beam of light, the diameter of the core of the fibers used in each amplification stage is also increased in size. For example, the core diameter of the fiber coupling modulator 158 (FIG. 3) with circulator 164 (FIG. 3) may be 5 micrometers, which can accommodate a pulse energy of a few nanojoules. EDF 166 (FIG. 3) may have a core diameter of 10 micrometers, which can accommodate pulse energy of a few microjoules. EDF 184 (FIG. 3) may have a core diameter of 20 micrometers, which can accommodate pulse energy of tens of microjoules. EYDF 210 (FIG. 4A), as well as fibers 256₁, 256₂ and 256_{N}, may each have a core diameter of 35 micrometers, which can accommodate a pulse energy of hundreds of microjoules. Finally, EYDF 220 may have a core diameter of 50 micrometers, which can accommodate pulse energy of a few millijoules. This increase in fiber core diameter is necessary to prevent an amplified beam of light from entering a fiber core at energy above the destruction threshold of the fiber core or above the threshold of non-linear effects. For example, if a 50 microjoule beam of light were to enter into a fiber with a core diameter of 5 micrometers, the fiber would be damaged, as a fiber with such a core diameter cannot handle pulse energies of 50 microjoules.

As mentioned above with reference to FIGS. 3, 4A and 4B, filters are used in the pre-amplifier and power amplifier stages in fiber laser 130 to prevent ASE and SBS from destroying the components of the fiber laser. Because of the high pulse energy involved in fiber laser 130, ASE and SBS can easily reflect back into a section of the fiber laser at a pulse energy above the destruction threshold of the fiber core of that section or above the threshold of non-linear effects, thereby breaking the fiber or fiber elements.

In general, pulsed beam of light 250 has the same pulse energy as pulsed beam of light 230. In comparison with power amplifier 200, power amplifier 240 reduces the risk of damage to fiber laser 130 (FIG. 2), since less pulse energy is propagated in each amplification channel in power amplifier 240 than in the second amplification stage of power amplifier 200. Each amplification channel in power amplifier 240 provides beams of light, with pulse energies on the order of hundreds of microjoules, to optical combiner 248. The second amplification stage of power amplifier 200 provides beams of light, with pulse energies on the order of a few millijoules, to WDM 224. Also, since power amplifier 240 transmits pulsed beams of light at lower pulse energy than power amplifier 200, the core diameter of the fibers in power amplifier 240 can be smaller in size, thereby output pulsed beam of light 250 has a smaller beam divergence than pulsed beam of light 230. It is noted that the smaller the beam divergence, the higher the brightness of light is. Since power amplifier 240 has N amplifying channels, and thus N output fibers, the output energy of power amplifier 240 is N times higher than the output energy of power amplifier 200.

Reference is now made to FIG. 4C, which is a schematic illustration of the power amplifier of FIG. 2, generally referenced 300, constructed and operative in accordance with another embodiment of the disclosed technique. It is noted that power amplifier 300 is constructed in a parallel configuration, and includes N parallel amplification channels. Power amplifier 300 includes an isolator 302, a 1:N (i.e., 1-to-N) coupler 304, a phase modulator controller 305, amplification channels 306₁, 306₂ and 306_{N} and an N:1 (i.e., N-to-1) optical combiner 308. It is noted that the ‘N,’ in 1:N coupler 304 and N:1 optical combiner 308, can be a natural number, which determines the number of amplification channels in power amplifier 300. It is further noted that hereinafter, 1:N coupler 304 will be referred to as coupler 304, and N:1 optical combiner 308 will be referred to as optical combiner 308. Coupler 304 and optical combiner 308 are both polarization maintaining. Optical combiner 308 can include mirrors (not shown), for optically combining N beams of light into a single beam of light. Isolator 302 is optically coupled with coupler 304. Coupler 304 is optically coupled with amplification channels 306₁, 306₂ and 306_{N}, which are in turn each optically coupled with optical combiner 308. Phase modulator controller 305 is coupled with each of amplification channels 306₁, 306₂ and 306_{N}. Isolator 302 is optically coupled with pre-amplifier 134 (FIG. 2).

Amplification channels 306₁, 306₂ and 306_{N} are identical to one another. As such, only amplification channel 306₁ will be fully described as the full description of the other amplifiers are identical. Amplification channel 306₁ includes a phase modulator 312₁, a first amplification stage 314₁ and a second amplification stage 316₁. First amplification stage 314₁ is optically coupled with second amplification stage 316₁. First amplification stage 314₁ is identical to first amplification stage 202 of FIG. 4A, with the exception of the isolator included therein. It is noted that first amplification stage 202 (FIG. 4A) includes an isolator, whereas first amplification stage 314₁ does not include an isolator, since isolator 302 is included in power amplifier 300 before amplification channels 306₁, 306₂ and 306_{N}. First amplification stage 314₁ therefore includes an erbium-ytterbium doped fiber (herein abbreviated EYDF), a WDM, a pump diode, and fiber optic cable (all not shown). A passive saturable absorber (not shown) may optionally be included in first amplification stage 314₁ for absorbing ASE and SBS. The WDM can be a custom free space combiner. The pump diode can be a conductive cooled, fiber coupled single emitter laser diode, or a bar array laser diode. The WDM is optically coupled with the pump diode, the EYDF and second amplification stage 316₁. The fiber optic cable optically couples the pump diode to the WDM. The EYDF can be a single mode, double clad, large mode area, polarization maintaining fiber (see FIG. 5B). The pump diode can be a fiber coupled laser diode, or a laser diode array. All the components in first amplification stage 314₁ are coupled with one another by optical fibers. It is noted that first amplification stage 314₁ is operative identically to first amplification stage 202 of FIG. 4A.

Second amplification stage 316₁ is identical to second amplification stage 204 of FIG. 4A. Second amplification stage 316₁ includes a filter, an EYDF, a WDM, a pump diode, and a fiber optic cable (all not shown). A passive saturable absorber (not shown) may optionally be included in second amplification stage 316₁ for absorbing ASE and SBS. The filter can be a band pass filter, an isolator, a switch or a Fabry-Perot (FP) filter. The WDM can be a custom free space combiner. The pump diode can be a conductive cooled, fiber coupled single emitter laser diode, or a bar array laser diode. The filter is optically coupled with the EYDF and the WDM. The WDM is optically coupled with the pump diode and the EYDF. The fiber optic cable optically couples the pump diode to the WDM. The EYDF can be a single mode, double clad, large mode area, polarization maintaining fiber (see FIG. 5B). The pump diode can be a fiber coupled laser diode. Since the energy transmitted through second amplification stage 316₁ is the largest in amplifier 306₁, the SBS effect therein is therefore thought to be the strongest. It is noted that second amplification stage 316₁ is operative identically to second amplification stage 204 of FIG. 4A.

Phase modulator 312₁ is optically coupled with first amplification stage 314₁ and coupled with phase modulator controller 305. It is noted that each of phase modulators 312₁, 312₂ and 312_{N} are coupled with phase modulator controller 305. Each of phase modulators 312₁, 312₂ and 312_{N} are optically coupled with coupler 304. Each of second amplification stages 316₁, 316₂ and 316_{N} are optically coupled with optical combiner 308. All the components in amplification channels 306₁, 306₂ and 306_{N} are coupled with one another by fibers.

Isolator 302 receives a pulsed beam of light, from pre-amplifier 134. As mentioned with reference to FIG. 2, the energy of the pulsed beam of light that initially reaches power amplifier 300 is below the limit of beginning to exhibit SBS effects. Power amplifier 300 further amplifies the pulsed beam of light. Isolator 302 is included in power amplifier 300 in order to prevent back reflections and ASE, coming from pulsed beams of light having a pulse energy on the order of tens or hundreds of microjoules, from reflecting back into pre-amplifier 134 (FIG. 2). This prevention is further enhanced by band pass filter 190 (FIG. 3), with which isolator 302 is coupled. Isolator 302 is also used for preventing pump light from the pump diodes, which are included in amplification channels 306₁, 306₂ and 306_{N}, from interfering with pre-amplifier 134, as mentioned above regarding band pass filter 178 (FIG. 3) and band pass filter 190. Isolator 302 then provides the pulsed beam of light to coupler 304, which splits the pulsed beam of light into N beams of light. For example, coupler 304 can split the pulsed beam of light into 4 beams of light. Each of the N beams of light is provided to each one of amplification channels 306₁, 306₂ and 306_{N}.

Each amplification channel then further amplifies the pulsed beam of light. In amplification channel 306₁, phase modulator 312₁ receives a split pulsed beam of light from coupler 304. Phase modulator 312₁ then directs the pulsed beam of light towards first amplification stage 314₁. First amplification stage 314₁ amplifies the pulsed beam of light, as described with reference to first amplification stage 202 (FIG. 4A). First amplification stage 314₁ then provides the pulsed beam of light to second amplification stage 316₁. Second amplification stage 316₁ then further amplifies the pulsed beam of light, as described with reference to second amplification stage 204 (FIG. 4A).

Each amplification channel then provides the amplified pulsed beam of light, which traveled there through, to optical combiner 308, which combines all the N beams of light into a single beam of light 310. The energy of combined beam of light 310 is significantly higher than the energy of each single light beam. In this manner, the output light beam energy achieved is higher than the limit of each single amplification channel. The pulse energy of each of the N beams of light exiting amplification channels 306₁, 306₂ and 306_{N} is approximately a few hundred microjoules.

In general, optical combiner 308 optically combines the pulsed beams of light exiting amplification channels 306₁, 306₂ and 306_{N}, such that none of the pulsed beams of light interference destructively, thereby attenuating the pulse energy of the combined single pulsed beam of light. Destructive interference between the pulsed beams of light exiting amplification channels 306₁, 306₂ and 306_{N} is prevented by phase modulator controller 305. Phase modulator controller 305 modulates the phase of each of the N beams of light, provided by coupler 304 to each of phase modulators 312₁, 312₂ and 312_{N}, such that there is no phase difference between the phases of each of the N beams of light. As such, when the N beams of light exit amplification channels 306₁, 306₂ and 306_{N} towards optical combiner 308, each beam of light will exit with the same phase and will therefore interfere constructively in optical combiner 308. Optical combiner 308 then outputs a pulsed beam of light 310. Pulsed beam of light 310 can be directed towards a volume of interest to be scanned in order to detect air turbulence. The energy of pulsed beam of light 310 is approximately a few millijoules.

Reference is now made to FIG. 5A, which is a schematic illustration of the cross-section of an optical fiber, generally referenced 270, used in the prior art. Optical fiber 270 includes a core 272, a cladding 274 and a coating 276. It is noted that core 272, cladding 274 and coating 276 are each circular in shape. Core 272 is surrounded by cladding 274, and cladding 274 is surrounded by coating 276. Core 272 and cladding 274 are both made of glass, with the index of refraction of core 272 being higher than the index of refraction of cladding 274. Beams of light are transmitted down core 272. Since cladding 274 has a lower index of refraction than core 272, cladding 274 effectively functions as a mirror that reflects the beams of light transmitted down core 272. Cladding 274 enables beams of light to be transmitted down core 272. Coating 276 protects cladding 274 and core 272. Since cladding 274 functions as a mirror, and hence, no part of the beam of light transmitted down core 272 enters cladding 274, the pulse energy of the beam of light is dependent on the diameter of core 272. As mentioned above with reference to FIG. 4B, fibers have a destruction threshold which determines how much pulse energy can be transmitted down a particular size core without causing damage or destroying the fiber. The destruction threshold is directly related to the core diameter. As such, higher energy pulses require larger core diameters.

Reference is now made to FIG. 5B, which is a schematic illustration of the cross-section of an optical fiber, generally referenced 280, constructed and operative in accordance with another embodiment of the disclosed technique. Optical fiber 280 includes doped core 282, undoped core 284, cladding 286 and coating 290. Doped core 282 and undoped core 284 are each elliptical in shape, such that the major axes of both ellipses substantially coincide. Cladding 286 has a double-D shape cross section, for if cladding 286 were to be split longitudinally, as indicated by dotted line 288, each side of cladding 286 would have a D-shape. Undoped core 284 is sometimes referred to as a “pedestal”. The elliptical shape of doped core 282 and undoped core 284 enables birefringence (i.e., double refraction) in optical fiber 280. The elliptical shape also enables optical fiber 280 to be polarization maintaining. The cross section area of undoped core 284 is substantially larger (i.e., by one order of magnitude) than the cross section area of doped core 282, in order to reduce amplification of a light beam propagating in undoped core 284.

Optical fiber 280 can be used as a fiber amplifier, coupled with a pump diode (e.g., EYDF 210 of FIG. 4A). In this case, erbium-ytterbium doping is usually required inside doped core 282, to allow amplification of a light beam passing there through. On the one hand, to enable high pump power to be provided by the pump diode into optical fiber 280, a diameter 292 of cladding 286 should be enlarged. On the other hand, in order to provide good pump absorption in doped core 282, diameter 292 of cladding 286 should be reduced. Thus, the cross section area of cladding 286 is adjusted to be large enough (i.e., relative to dimensions of optical fibers used to provide light beams from a laser diode) to enable a sufficient amount of pump power, yet small enough (i.e., relative to the cross section area of doped core 282) to provide high pump absorption in doped core 282.

Optical fiber 280 can also be used for connecting two components of a fiber laser system, without being coupled with a pump diode, (e.g., the fiber connecting isolator 206 and pre-amplifier 134 in FIG. 4A). In this case, doped core 282 is usually not doped with erbium or ytterbium. Doped core 282 can be doped with other substances, such as germanium, phosphor, aluminum, boron, fluorine and the like, to create a difference between the refraction coefficients of doped core 282 and of undoped core 284.

As mentioned above with reference to FIG. 4B, since each amplification stage of fiber laser 130 (FIG. 2) significantly increases the energy of the beam of light, the diameter of the core of the fibers used in each amplification stage is also increased in size to accommodate the increase in pulse energy. In general, SM fibers have a core diameter on the order of a few micrometers. When the core diameter is on the order of tens of micrometers, fibers are usually multimode (herein abbreviated MM), which allow a plurality of modes to be transmitted in the fiber core. Since MM operation of a fiber increases divergence within the fiber, such fibers can not be used in diffraction limited lasers, such as fiber laser 130.

The numerical aperture (NA) of an optic fiber is a measure of the range of angles of entry a pulsed beam of light can have in order to enter and propagate in the fiber core. As the NA decreases, the fiber can receive beams of light having an entry angle into the fiber which fall within a smaller range of angles. Undoped core 284 has a refractive index which is slightly lower that the refractive index of doped core 282, which reduces the NA of doped core 282. The NA of doped core 282 is reduced in order to allow the propagation of only a single mode, and to eliminate undesirable high modes.

In double clad fibers, skew rays, which enter the cladding from a pump diode, need to be reflected into the core in order to be absorbed. Skew rays which do not reflect into the core may exit the optical fiber without being absorbed, and pulse energy will therefore be lost. If cladding 286 were round in shape, then skew rays that enter cladding 286 would not enter into doped core 282. As such, cladding 286, as well as doped core 282 and undoped core 284, are constructed to be asymmetrical (i.e., non-circular). The double-D asymmetric shape of cladding 286 thus enables skew rays traveling inside cladding 286 to enter undoped core 284 and doped core 282. In this manner an effective mixing of straight rays and skew rays is achieved, by changing the trajectory of the skew rays and redirecting them into undoped core 284 and doped core 282. Furthermore, when optical fiber 280 is used as a fiber amplifier (i.e., coupled with a pump diode), the double-D asymmetric shape of cladding 286 also redirects pump light into undoped core 284 and doped core 282, thereby preventing losses of pump power within optical fiber 280.

Optical fiber 280 may be coiled for enabling a compact configuration. The coiling can be performed, for example, around a cylinder, inside a kidney shaped cavity or inside a figure-eight shaped cavity. The major axes of doped core 282 and undoped core 284 substantially coincide with dotted line 288, dividing cladding 286 in two. If optical fiber 280 is coiled, then this orientation of doped core 282 and undoped core 284 with respect to double-D shaped cladding 286 delivers a specific desired orientation to doped core 282 in coiled optical fiber 280. When optical fiber 280 is coiled, dotted line 288 is substantially perpendicular to a symmetry axis of the coil. In this manner, the orientation of optical fiber 280 is evident and maintained throughout the coil. Furthermore, the shape and orientation of coiled optical fiber 280, maintains optical fiber 280 as an SM fiber, and prevents it from becoming an MM fiber.

It will be appreciated by persons skilled in the art that the disclosed technique is not limited to what has been particularly shown and described hereinabove. Rather the scope of the disclosed technique is defined only by the claims, which follow.

1. Fiber laser, for producing a single mode (SM) polarized single frequency (SF) high-power laser beam of light, said fiber laser comprising:
an SF laser oscillator, for generating a laser beam of light having a predetermined frequency;
a fiber laser pre-amplifier, optically coupled with said laser oscillator, for pre-amplifying said laser beam of light, said fiber laser pre-amplifier including:
a double pass amplifying stage for amplifying said laser beam of light:
a polarizer, for preventing non-Polarized laser beams of lights from propagating through said fiber laser pre-amplifier; and
a delay line of a predetermined length,
a high-power fiber laser power amplifier, optically coupled with said fiber laser pre-amplifier, for amplifying said laser beam of light, said high-power fiber laser power amplifier including:
a fiber optic isolator, optically coupled with said fiber laser pre-amplifier;
at least one first amplification stage, for amplifying said laser beam of light; and
at least one second amplification stage, optically coupled with said at least one first amplification stage, for further amplifying said laser beam of light, said at least one second amplification stage outputting said laser beam of light,
wherein the fibers used in said fiber laser are Polarization maintaining (PM).

2. The fiber laser of claim 1, wherein said SF laser oscillator is selected from the list consisting of:
a single mode laser;
a continuous wave laser;
a distributed feedback laser diode; and
a polarization maintaining laser.

3. The fiber laser of claim 1, wherein said fiber laser is constructed from an erbium doped fiber.

4. The fiber laser of claim 1, further comprising at least one optical fiber for optically coupling the components of said fiber laser.

5. The fiber laser of claim 4, wherein said at least one optical fiber is a single mode fiber.

6. The fiber laser of claim 1, wherein said laser beam of light has a pulse length of hundreds of nanoseconds.

7. The fiber laser of claim 1, wherein said laser beam of light has a pulse repetition rate ranging from tens of hertz to hundreds of kilohertz.

8. The fiber laser of claim 1, wherein said laser beam of light has a wavelength of 1550 nanometers.

9. The fiber laser of claim 1, wherein said fiber laser pre-amplifier comprises:
a coupler, optically coupled with said SF laser oscillator, for splitting said laser beam of light into two laser beams of light;
a modulator, optically coupled with said coupler, for modulating one of said two laser beams of light;
a pre-amplifier stage, optically coupled with said modulator, for amplifying said one of said two laser beams of light twice; and
a booster stage, optically coupled to said pre-amplifier stage and said high-power fiber laser power amplifier, for further amplifying said one of said two laser beams of light.

10. The fiber laser of claim 9, wherein the other of said two laser beams of light is used as a reference output.

11. The fiber laser of claim 9, wherein said pre-amplifier stage comprises:
a circulator, optically coupled with said modulator, for directing said one of said two laser beams of light in at least one direction;
an erbium doped fiber (EDF), optically coupled with said circulator, for receiving said one of said two laser beams of light from said circulator and for amplifying said one of said two laser beams of light, thereby yielding a single amplified beam of light;
a wavelength division multiplexer (WDM), optically coupled with said EDF;
a narrow band reflector, optically coupled with said WDM, for reflecting said single amplified beam of light back towards said EDF;
a pump diode, optically coupled with said WDM, for pumping said EDF; and
a band pass filter, optically coupled with said circulator and said booster stage, for transmitting a laser beam of light only at the wavelength of said laser beam of light, initially emitted from said SF laser oscillator,
wherein said EDF amplifies said single amplified beam of light a second time, after reflection from said narrow band reflector, thereby yielding a double amplified beam of light, and
wherein said circulator directs said double amplified beam of light to said band pass filter.

12. The fiber laser of claim 11, wherein said pre-amplifier stage further comprises:
a passive saturable absorber, for suppressing amplified spontaneous emissions (ASE); and
a polarizer, optically coupled between said WDM and said narrow band reflector, for preventing non-polarized laser beams of lights from propagating through said pre-amplifier stage.

13. The fiber laser of claim 11, wherein said narrow band reflector is selected from the list consisting of: a narrow band Bragg reflector and a fiber Bragg grating.

14. The fiber laser of claim 11, wherein said pump diode generates a beam of light, for pumping said EDF, on the order of hundreds of milliwatts.

15. The fiber laser of claim 11, wherein said band pass filter has a narrow bandwidth.

16. (canceled)

17. The fiber laser of claim 1, wherein said fiber laser pre-amplifier comprises two amplification stages.

18. (canceled)

19. The fiber laser of claim 1, wherein said predetermined length is substantially 100 meters when said fiber laser is used to detect turbulent air.

20. The fiber laser of claim 11, wherein said pre-amplifier stage further comprises:
a delay line between said WDM and said narrow band reflector; and
a polarizer, optically coupled between said WDM and said narrow band reflector.

21. The fiber laser of claim 9, wherein said booster stage comprises:
a wavelength division multiplexer (WDM), optically coupled with said pre-amplifier stage, for receiving said one of said two laser beams of light amplified twice;
a pump diode, optically coupled with said WDM;
an erbium doped fiber (EDF), optically coupled with said WDM, for amplifying said one of said two laser beams of light amplified twice a third time; and
a band pass filter, optically coupled with said EDF and said high-power fiber laser power amplifier, for preventing amplified spontaneous emissions (ASE) from said EDF from passing to said high-power fiber laser power amplifier,
wherein said pump diode pumps said EDF.

22. The fiber laser of claim 21, wherein said EDF is a large mode area fiber.

23. The fiber laser of claim 21, wherein said pump diode generates a beam of light, for pumping said EDF, on the order of watts.

24. The fiber laser of claim 21, wherein said band pass filter has a narrow bandwidth.

25. The fiber laser of claim 21, wherein said band pass filter transmits a laser beam of light only at the wavelength of said laser beam of light, initially emitted from said SF laser oscillator.

26. The fiber laser of claim 1, wherein said at least one first amplification stage further comprises:
an erbium-ytterbium doped fiber (EYDF), optically coupled with said fiber optic isolator, for amplifying said laser beam of light;
a wavelength division multiplexer (WDM), optically coupled with said EYDF and said at least one second amplification stage, for directing said amplified laser beam of light to said at least one second amplification stage; and
a pump diode, optically coupled with said WDM, for pumping said EYDF.

27. The fiber laser of claim 26, wherein said WDM is a custom free space combiner.

28. The fiber laser of claim 26, wherein said pump diode is selected from the list consisting of:
a conductive cooled single emitter laser diode;
a bar laser diode;
a laser diode array; and
a fiber coupled laser diode.

29. The fiber laser of claim 26, wherein said EYDF is a large mode area fiber.

30. The fiber laser of claim 26, wherein said pump diode generates a beam of light, for pumping said EYDF, on the order of tens of watts.

31. The fiber laser of claim 1, wherein said fiber optic isolator is a free space optical device.

32. The fiber laser of claim 1, wherein said fiber optic isolator prevents stimulated Brillouin scattering (SBS) from reflecting back into said fiber laser pre-amplifier.

33. The fiber laser of claim 1, wherein said fiber optic isolator has a narrow bandwidth.

34. The fiber laser of claim 1, wherein said fiber optic isolator transmits a laser beam of light only at the wavelength of said laser beam of light, initially emitted from said SF laser oscillator.

35. The fiber laser of claim 1, wherein said at least one second amplification stage further comprises:
a filter, optically coupled with said at least one first amplification stage;
an erbium-ytterbium doped fiber (EYDF), optically coupled with said filter, for further amplifying said laser beam of light;
a wavelength division multiplexer (WDM), optically coupled with said EYDF, for outputting said further amplified laser beam of light;
a pump diode, optically coupled with said WDM, for pumping said EYDF.

36. The fiber laser of claim 35, wherein filter is selected from the list consisting of:
a band pass filter;
an isolator;
a switch; and
a Fabry-Perot (FP) filter.

37. The fiber laser of claim 35, wherein said filter has a bandwidth which is substantially narrower than the bandwidth of the Brillouin shift.

38. The fiber laser of claim 35, wherein said filter has a bandwidth which is substantially narrower than the bandwidth of the ASE shift.

39. The fiber laser of claim 35, wherein said filter transmits a laser beam of light only at the wavelength of said laser beam of light, initially emitted from said SF laser oscillator.

40. The fiber laser of claim 35, wherein said filter prevents stimulated Brillouin scattering (SBS) and amplified spontaneous emissions (ASE) from said EYDF, from destroying said amplified laser beam of light.

41. The fiber laser of claim 35, wherein said EYDF is a large mode area fiber.

42. The fiber laser of claim 35, wherein said WDM is a custom free space combiner.

43. The fiber laser of claim 35, wherein said pump diode is selected from the list consisting of:
a conductive cooled single emitter laser diode;
a bar laser diode; and
a fiber coupled laser diode.

44. The fiber laser of claim 1, wherein said at least one first amplification stage includes a plurality of first amplification stages, wherein said at least one second amplification stage includes a plurality of second amplification stages, wherein said high-power fiber laser power amplifier further includes:
a channel coupler, optically coupled with said isolator, for splitting said laser beam of light into a plurality of split laser beams of light;
a plurality of phase modulators, each coupled with said channel coupler, each of said phase modulators coupled with a respective one of said first amplification stages, each of said phase modulators located before each of said first amplification stages, for modulating the phase of a respective one of said split laser beams of light;
a phase modulator controller, optically coupled with said phase modulators, for controlling the phase of each of said split beams of light, such that no phase difference exists between the phases of said split beams of light; and
an optical combiner, optically coupled with the output of each of said second amplification stages, for combining said split beams of light into a single amplified beam of light.

45. The fiber laser of claim 4, wherein the diameter of the core of said at least one optical fiber increases as the amplification of said laser beam of light increases.

46-69. (canceled)
